(19) United States
(12) Patent Application Publication
(10) Pub. No.: US 2014/0158557 A1
(43) Pub. Date: Jun. 12, 2014

(54) Gas Storage and Release Into Packaging After Filling

(71) Applicant: BASF Corporation, Florham Park, NJ (US)

(72) Inventors: William Dolan, Yardley, PA (US); Ahmad Moini, Princeton, NJ (US); Martin W. Kraus, Westfield, NJ (US)

(73) Assignee: BASF Corporation, Florham Park, NJ (US)

(21) Appl. No.: 14/104,550

(22) Filed: Dec. 12, 2013

Related U.S. Application Data
(60) Provisional application No. 61/736,328, filed on Dec. 12, 2012.
(60) Provisional application No. 61/862,779, filed on Aug. 6, 2013.

(51) Int. Cl. F17C 11/00

(52) U.S. Cl. CPC F17C 11/00
USPC 206/7; 141/4

(57) ABSTRACT

Disclosed are storage vessel pressurization components and methods for use with a storage vessel having a headspace with a first gaseous species. The storage vessel pressurization component including a storage medium with a second gaseous species adsorbed thereon. The storage vessel pressurization component configured to adsorb the first gaseous species from the headspace and release the second gaseous species into the headspace. Articles comprising the storage vessel pressurization component are also described.

### CROSS-REFERENCE TO RELATED APPLICATIONS

This application claims priority to U.S. Provisional Application Nos. 61/736,328, filed Dec. 12, 2012 and 61/862,779, filed Aug. 6, 2013, the entire disclosures of which are hereby incorporated by reference herein.

### BACKGROUND

Embodiments of the invention generally relate to gas storage systems for packaging. More specifically, embodiments of the invention are directed to devices which can be enclosed in a package and capable of releasing a stored gas into the package while adsorbing a different gas.

Beverages bottles, typically plastic, are often filled and capped at elevated temperatures. This process, also called an “aseptic fill”, is commonly used for packaging perishable products. When the bottle has been capped, water in the bottle will have a vapor pressure commensurate with the filling temperature. For example, an aseptic fill performed at a temperature of about 160° F. (71° C.) would have a partial pressure of water of approximately 4.5 psia (pounds per square inch absolute) or 31 kPa. When the bottles subsequently cool to room temperature the water vapor pressure drops to approximately 0.3 psia (2 kPa). The net effect is a decrease in pressure within the bottle.

This decrease in pressure can result in the deformation of the bottle or package being used. This causes the plastic (PET) bottle to partially collapse if the bottle walls are thin. To solve this problem, many packages are manufactured with thicker plastic walls. The thicker walls result in an increased strength, thereby minimizing the amount of deformation. However, bottles with thicker plastic are more expensive to manufacture and are less environmentally-friendly as more material is required.

Therefore, there is a need in the art for devices and methods of filling bottles and packages at elevated temperatures while minimizing or eliminating product deformation upon cooling.

### SUMMARY

A first embodiment of the invention is directed to a storage vessel pressurization component for use with a storage vessel having a headspace with a first gaseous species. The storage vessel pressurization component comprises a gas storage medium having a second gaseous species sorbed thereon. The gas storage medium is configured to release the second gaseous species to the headspace of the storage vessel and adsorb the first gaseous species from the headspace of the storage vessel.

In a second embodiment, the first embodiment can be modified wherein the gas storage medium comprises an adsorbent.

In a third embodiment, any of the first or second embodiment can be modified wherein the adsorbent comprises one or more of carbon, activated carbon, a zeolite and a metal organic framework (MOF) composition.

In a fourth embodiment, any of the first through third embodiment can be modified wherein the adsorbent comprises a zeolite.

In a fifth embodiment, the fourth embodiment can be modified the zeolite is selected from the group consisting of 4A zeolite, 5A zeolite and mixtures thereof.

In a sixth embodiment, any of the first through fifth embodiments can be modified wherein the storage vessel is a bottle.

In a seventh embodiment, the sixth embodiment can be modified wherein the bottle is a beverage bottle.

In an eighth embodiment, any of the first through seventh embodiments can be modified wherein the storage vessel is a can.

In a ninth embodiment, any of the first through eighth embodiments can be modified wherein the storage vessel is a flexible package.

In a tenth embodiment, any of the first through ninth embodiments can be modified wherein the first gaseous species comprises water vapor.

In an eleventh embodiment, any of the first through tenth embodiments can be modified wherein the second gaseous species is selected from the group consisting of helium, argon, oxygen, nitrogen, carbon dioxide and combinations thereof.

In a twelfth embodiment, any of the first through eleventh embodiments can be modified wherein the first gaseous species comprises water vapor and the second gaseous species comprises nitrogen.

In a thirteenth embodiment, any of the first through twelfth embodiments can be modified wherein the headspace has a first volume before attachment of the storage vessel pressurization component to the storage vessel and a second volume after the attachment of the storage vessel pressurization component to the storage vessel, the second value greater than about 80% of the first volume.

In a fourteenth embodiment, the thirteenth embodiment can be modified wherein the storage vessel pressurization component is stored at temperature less than about 15° C. prior to attachment of the storage vessel pressurization component to the storage vessel.

In a fifteenth embodiment, any of the first through fourteenth embodiments can be modified wherein the component comprises a sachet.

In a sixteenth embodiment, any of the first through fifteenth embodiments can be modified further comprising a material impermeable to the first gaseous species, the material including at least one opening to allow the first gaseous species to diffuse therethrough.

In a seventeenth embodiment, the sixteenth embodiment can be modified wherein the material impermeable to the first gaseous species comprises a polymer.

In an eighteenth embodiment, any of the first through seventeenth embodiments can be modified further comprising a polymer barrier.

In a nineteenth embodiment, the eighteenth embodiment can be modified wherein the polymer barrier is gas permeable.

In a twentieth embodiment, the eighteenth embodiment can be modified wherein the polymer barrier is substantially impermeable to one or more of the first gaseous species and the second gaseous species.

In a twenty-first embodiment, any of the first through twentieth embodiments can be modified wherein the component is stored in an environment comprising one or more of sub-room temperatures and super-atmospheric pressure of the second gaseous species.

In a twenty-second embodiment, any of the first through twenty-first embodiments can be modified wherein adsorbing the first gaseous species comprises contacting the fluid.

A twenty-third embodiment is directed to a storage vessel pressurization component for use with a bottle having a liquid and a headspace with a first volume at elevated temperature. The headspace comprises water vapor and the storage vessel pressurization component comprising a sorbent with an amount of second gaseous species adsorbed thereon. The second gaseous species comprises nitrogen and the amount of the second gaseous species is sufficient to exchange with the water vapor in the headspace so that when liquid cools to about room temperature the headspace has a second volume greater than about 80% of the first volume. The twenty-third embodiment can be modified to incorporate the limitations of any or all of the second through twenty-second embodiments.

A twenty-fourth embodiment is directed to a method of manufacturing a beverage. A storage vessel having an opening is filled with an aqueous liquid to leave a known headspace volume above the liquid. The storage vessel is filled at elevated temperatures greater than about 40° C. and the headspace volume comprises a first gaseous species comprising water vapor. A storage vessel pressurization component is placed adjacent to the opening in the bottle. The storage vessel pressurization component comprises a sorbent with an amount of second gaseous species adsorbed thereon and the second gaseous species comprising nitrogen. The bottle is sealed with the storage vessel pressurization component adjacent the opening. The storage vessel is cooled to room temperature. The amount of the second gaseous species is sufficient to exchange with the first gaseous species in the headspace volume so that when the aqueous liquid cools to about room temperature the headspace has a second volume greater than about 80% of the first volume.

A twenty-fifth embodiment is directed to a method of manufacturing a beverage. A storage vessel having an opening is filled with an aqueous liquid to leave a known headspace volume above the liquid. The storage vessel is filled at elevated temperatures greater than about 40° C. and the headspace volume comprises a first gaseous species comprising water vapor. A storage vessel pressurization component is placed in the bottle. The storage vessel pressurization component comprises a sorbent with an amount of second gaseous species adsorbed thereon and the second gaseous species comprising nitrogen. The bottle is sealed with the storage vessel pressurization component therein. The storage vessel is cooled to room temperature. The amount of the second gaseous species is sufficient to exchange with the first gaseous species in the headspace volume so that when the aqueous liquid cools to about room temperature the headspace has a second volume greater than about 80% of the first volume.

In a twenty-sixth embodiment, any of the twenty-fourth or twenty-fifth embodiment is modified further comprising removing the storage vessel pressurization component from storage in an environment having one or more of sub-room temperature and elevated pressure.

The twenty-fourth through twenty-sixth embodiments can be modified to incorporate limitations of any or all of the second through twenty-second embodiments.

A twenty-seventh embodiment is directed to an article comprising a bottle holding a fluid and having a headspace. A storage vessel pressurization component is within the bottle, wherein upon assembly of the bottle and the storage vessel pressurization component, there is substantially no change in the volume of the headspace or pressure within the bottle. The twenty-seventh embodiment can be modified to incorporate any or all of the second through twenty-second embodiments.

A twenty-eighth embodiment is directed to an article comprising a storage vessel and a storage vessel pressurization component within the storage vessel. The storage vessel has an opening and a fluid contained therein and a headspace. The storage vessel pressurization component is within the storage vessel. The storage vessel pressurization component hos molecules sorbed thereon, the molecules comprising fluid molecules. The twenty-eighth embodiment can be modified to incorporate any or all of the second through twenty-second embodiments.

The foregoing has outlined, rather broadly, certain features and technical advantages of one or more embodiments of the invention. It should be appreciated by those skilled in the art that the specific embodiments disclosed may be readily utilized as a basis for modifying or designing other structures or processes. It should also be realized by those skilled in the art that such equivalent constructions do not depart from the spirit and scope of the invention as set forth in the appended claims.

### BRIEF DESCRIPTION OF THE DRAWINGS

FIG. 1A is an illustration of a storage vessel with a storage vessel pressurization component according to one embodiment;

FIG. 1B is an illustration of a storage vessel with a storage vessel pressurization component according to one embodiment;

FIG. 2 is an illustration of a storage media sachet according to one embodiment;

FIG. 3 is an illustration of a storage vessel pressurization component according to one embodiment;

FIG. 4 is a cross-sectional illustration of bottle cap with the storage vessel pressurization component of FIG. 3; and

FIG. 5 is an illustration of a storage vessel with a storage vessel pressurization component according to one embodiment.

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Generally, one or more embodiments of the invention are directed to components for the pressurization of a container or other storage mechanism. The components can include a storage material like molecular sieves, zeolites, metal-organic frameworks (MOF) or other storage material. The storage material may store a gas like nitrogen, argon, carbon dioxide, other gas or mixtures of gases. The container or other storage mechanism can then be applied to a bottle, can, package, or other vessel, where the gas is released.

Before, during, or after deployment of the container or other storage mechanism, a membrane may be pierced or otherwise activated before being applied to the bottle, can, package, or other vessel. The membrane may be a polyethylene, polypropylene, or like material. In some embodiments, the bottle is a beverage bottle. In other embodiments, the vessel is a flexible packaging such as a pouch or like vessel. For example, the pouch may be a beverage pouch.

Alternatively, the cap can have the adsorbent in a sachet and the cap will be need to be screwed on fast enough that during the step of screwing on the cap only a small amount of water is adsorbed.

The storage mechanism or material will adsorb water vapor and slowly release gas back into the package (such as a bottle) during or after capping. As the gas (such as nitrogen) is released it will pressurize the bottle after it has been capped. This would ensure that the bottle does not collapse after it has cooled and the water vapor pressure is decreased.

This would ensure that the bottle (or like package) keeps its structural integrity and does not collapse after the hot filled liquid (or other product) cools. This will then allow the manufacturer to design a package that uses less material (such as thinner plastic walls), thus saving in raw material costs and improving the sustainability of the package.

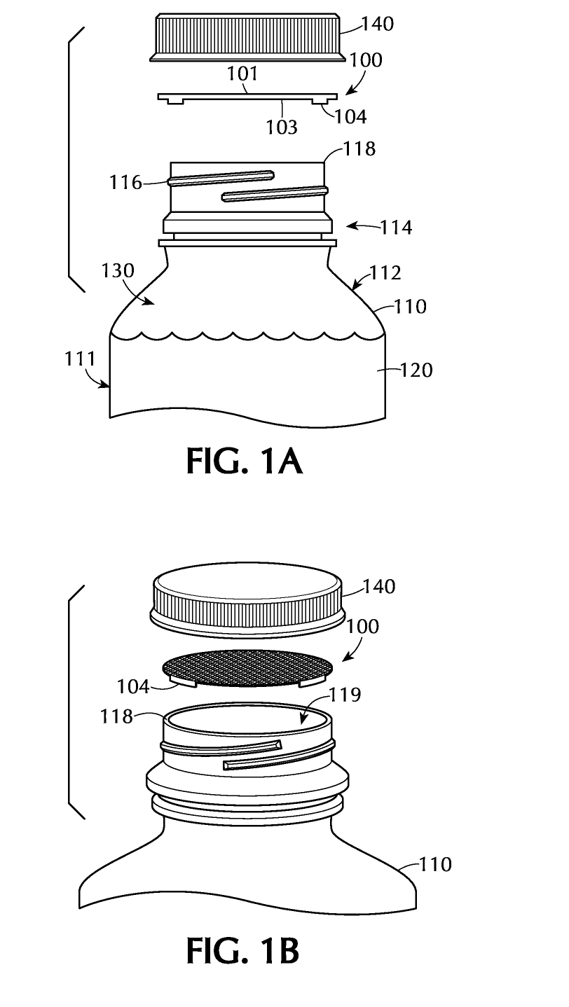

With reference to FIGS. 1A and 1B, one or more embodiments of the invention are directed to storage vessel pressurization components 100. As used in this specification and the appended claims, the term “storage vessel” refers to any container capable of holding a liquid in a sealed state. The storage vessel 110 shown in FIG. 1A and 1B is a bottle. For descriptive purposes, the storage vessel 110 shown in FIG. 1A may be simply referred to as a “bottle.” This can be any type of bottle including, but not limited to, a beverage storage bottle. Suitable storage vessels for use with embodiments of the invention include, but are not limited to bottles (e.g., plastic bottles, beverage bottles), cans and flexible packages.

As shown in the embodiment of FIGS. 1A and 1B, the storage vessel 110 includes a cylindrical portion 111, a dome portion 112 which narrows the diameter of the bottle from the cylindrical portion 111 to that of the neck 114. The neck 114 includes one or more screw threads 116 to allow a cap, or other component, to be connected to the bottle to seal the opening 119. The cap or other component could be connected in any suitable way, such as by a threadable connection (not shown). The opening 119 has a lip 118 forming a top of the bottle and allows a fluid to pass therethrough either into the bottle or from within the bottle. Those skilled in the art will understand that the description of the storage vessel 110 is merely exemplary and should not be taken as limiting the scope of the invention.

The storage vessel 110 is shown with an amount of a fluid 120 or beverage stored therein. While a fluid can be a liquid, gas, or flowable solid, this specification, without being limited thus, generally describes the fluid as a liquid. The fluid 120 can be any suitable fluid including, but not limited to, aqueous liquids like beverages, alcoholic liquids or organic liquids. In some embodiments, the fluid comprises a sports drink.

The space above the fluid 120 is referred to as headspace 130 and is generally filled with environmental gases and water vapor. As used in this specification and the appended claims, the term “environmental gases” refers to the gaseous makeup of the environment in which the storage vessel 110 was filled. For example, if a bottle is filled in a nitrogen environment excluding as much oxygen as possible, the environmental gases in the headspace 130 will be primarily nitrogen and water vapor from the liquid 120. For example, a bottle having a known volume is filled with a known volume of beverage, the difference between these volumes results in the headspace. As used in this specification and the appended claims, the terms, “fill”, “filling”, “filled” and the like when referring to the addition of fluid to a container, means that a known volume or mass of fluid is added to a container. The “filled” container may still have available space to hold more fluid.

The headspace 130 comprises a first gaseous species, generally the primary components of the fluid within the bottle. For example, if a bottle is filled with a sports drink (mostly water) in a nitrogen environment, the headspace would have nitrogen and a first gaseous species, in this case, water vapor. If the bottle were filled with an organic fluid, the first gaseous species would comprise vapors of the organic fluid.

Many storage vessels, like beverage bottles, are filled at elevated temperatures to maintain aseptic conditions. As used in this specification and the appended claims, the term “elevated temperature” means a temperature greater than room temperature (about 20° C. or 68° F.). In some embodiments, elevated temperature is greater than about 100° F., 104° F., 110° F., 120° F., 130° F., 140° F., 150° F., 160° F., 170° F. or 180° F. (or greater than about 38° C., 40° C., 43° C., 45° C., 49° C., 50° C., 54° C., 55° C., 60° C., 65° C., 66° C., 70° C., 71° C., 75° C., 77° C., 80° C. or 82° C.). The temperature of the fluid correlates to the density and partial pressure of the fluid which will affect the volume and composition of the headspace. The density of water is greatest at about 4° C. and an aqueous fluid would have a lower density at elevated temperature than at room temperature. The partial pressure of water is higher at elevated temperature than room temperature resulting in a headspace with more water vapor at elevated temperature than at room temperature.

Accordingly, one or more embodiments of the invention are directed to storage vessel pressurization components for use with a storage vessel. Referring again to FIGS. 1A and 1B, the storage vessel 110 can be filled with a fluid 120 leaving headspace 130. A storage vessel pressurization component 100 is positioned adjacent the openings 119 of the storage vessel 110 and fixed in place. Here, the storage vessel pressurization component 100 is fixed in place by the attachment of a cap 140 to the vessel 110. The cap 140 forms a gastight seal to protect the contents from contamination and spillage. In the embodiment shown, the cap 140 has internal screw threads (not shown) which cooperatively interact with the screw threads 116 on the neck 114 of the storage vessel 110 to form a tight seal.

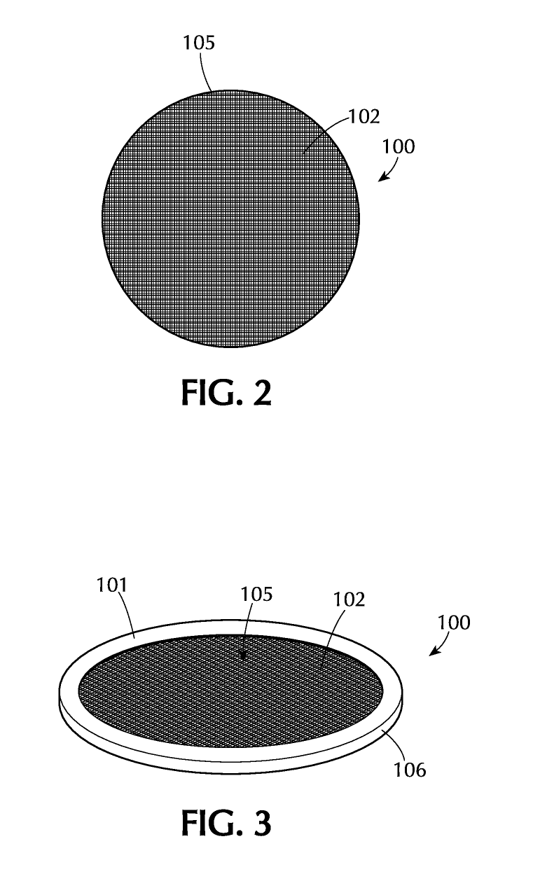

The headspace 130 of the storage vessel 110 comprises a first gaseous species and the environmental gases. For example, for an aqueous solution, the first gaseous species comprises water vapor and the environmental gases comprise the gases present when the vessel 110 is filled and capped. The storage vessel pressurization component 100 has a gas storage medium 102, as shown in FIG. 2. The terms “storage medium”, “adsorbent”, “sorbent”, “releasing medium”, “generating medium” and the like are used interchangeably. The gas storage medium 102, also referred to as a gas releasing medium or gas generating medium, has a second gaseous species sorbed thereon. In some embodiments, the second gaseous species is different from the first gaseous species. The gas storage medium 102 is configured to, effective to, or capable of releasing the second gaseous species into the headspace 130 of the storage vessel 110 and adsorb the first gaseous species from the headspace 130 of the storage vessel 110 and/or fluid 120 from the bottle.

While reference is made throughout this specification to the first gaseous species being adsorbed onto the storage medium (or releasing medium), it will be understood by those skilled in the art, that the fluid in the bottle, which is the source of the first gaseous species can also be adsorbed. The adsorption of the fluid can result in less, more or about the same change in headspace volume as adsorption of only the gaseous species. For example, water in the bottle creates water vapor as the first gaseous species. The water molecules can contact the storage medium and adsorb while the water molecules in the water vapor condense back into liquid water. If the same number of water molecules are adsorbed as the number of water vapor molecules that condense, the net effect is that the gaseous species has been transferred to the adsorbed species, just through an intermediate route. If less water molecules are adsorbed than condense, then the net effect is a decrease in headspace volume. Similarly, if more water molecules are adsorbed than condense, the net effect is an increase in headspace volume. However, the amount of storage medium used is small enough that there will likely be no appreciable difference, other than the specific mechanism. Those skilled in the art will understand that reference in the specification and claims to adsorption of the first gaseous species can also mean the combination of adsorption of liquid species with condensation of the gaseous species resulting in the net decrease of the first gaseous species.

As used in this specification and the appended claims, the term “gas storage medium” and the like refer to a composition which can either store and release a specific gaseous species or generate a specific gaseous species. Essentially, a “gas storage medium” is a composition which releases a desired species. The term storage is being used to mean any composition that can result in the presence of a gaseous species. For example, a gas storage medium can store nitrogen gas under some conditions and release the nitrogen gas under other conditions. In this example, the medium actually stores and releases nitrogen gas, either with or without, temporarily altering the chemical nature of the molecular bond. Another example of a “storage medium” is a composition which upon some stimulus, for example, reaction with liquid or gaseous water, generates a gaseous species like nitrogen. In this example, the composition does not “store” nitrogen in the traditional sense, but is a source for creating, releasing or generating nitrogen under the desired conditions. In a gas storage medium that generates the second gaseous species, the phrase “having a second gaseous species stored (or sorbed) thereon” means that the second gaseous species is derived from the existence and presence of the gas storage medium or generated by the gas storage medium. For example, nitrogen atoms present in the gas storage medium which combine to molecular nitrogen upon degradation, followed by release from the storage medium, can be said to have nitrogen stored therein. Additionally, the “gas storage medium” may also be referred to as a “gas releasing medium”. In some embodiments, the storage vessel pressurization component comprises a gas releasing medium having one or more of a second gaseous species and a composition from which a second gaseous species can be generated.

The pressurization component 100 can be any suitable form depending on the specific vessel being used. FIG. 1A shows a cross-section of a disc shaped pressurization component 100 having a shape similar to the shape of the bottle neck opening. The pressurization component 100 includes an optional leg 104 extending from a bottom side 103 of the pressurization component 100. The leg 104 can be circular so that it extends entirely around the component 100 or can be in multiple legs each extending a short distance, as shown in FIG. 1B. The leg 104 is positioned on the bottom side 103 of the component 100 so that it can be placed within the opening 119 of the bottle and prevents the component 100 from shifting or falling off of the bottle.

FIG. 2 shows an embodiment of the pressurization component 100 formed in a sachet 105. Suitable sachets include materials that can contain the storage medium 102 and allow the first gaseous species from the headspace and the second gaseous species from the storage medium 102 to pass through.

FIG. 3 shows another embodiment of a pressurization component 100 in which a toroid shaped housing 106 supports a sachet 105 containing the storage medium 102. The toroid shaped housing can be made of any suitable material including, but not limited to, high density polyethylene (HDPE) and low density polyethylene (LDPE). Here, the housing 106 can be sized to sit on the lip 118 of the bottle. The top side 101 of the pressurization component 100 can be either gas permeable or impermeable, as long as the bottom side 103 allows gas to move through. Polymer coating on one or both sides. Upon capping the vessel, the housing can remain in position on the lip 118 of the bottle. When the user opens the bottle, the component 100 will be on top of the lip 118 and must be discarded.

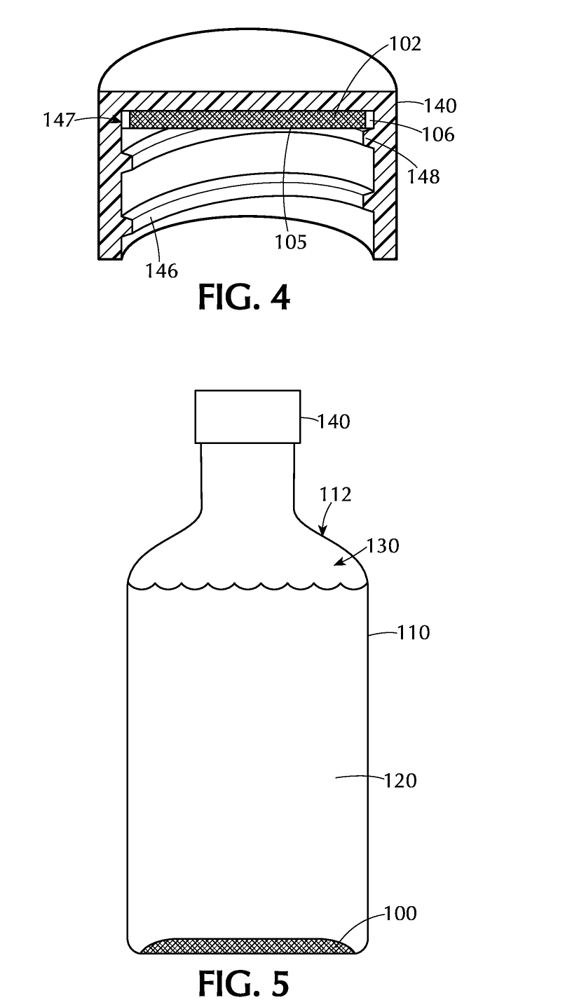

In the embodiment shown in FIG. 4, applying the cap 140 to the bottle forces the pressurization component 100 into a cavity 147 bounded by a ridge 148. In use, the cap 140 is screwed onto the neck of the bottle with the screw threads 146 on the cap 140 cooperatively interacting with the screw threads 116 on the neck 114 of the bottle. The downward directed force that is applied forces the pressurization component 100 to pass the ridge 148 and seat in the cavity 147. Upon removal of the cap from the bottle, the toroid shaped housing 106 of the pressurization component 100 is held in the cavity 147 and is prevented from falling out by the ridge 148. Thus, the pressurization component 100 does not need to be individually discarded by the user but will remain a portion of the cap 140.

Prior to placing the storage vessel pressurization component 100 into position adjacent the opening 119 of the vessel 110, the storage medium may have a second gaseous species sorbed thereon. Alternatively, the storage medium may degrade or otherwise generate a second gaseous species. This second species can be any suitable species and non-limiting examples include helium, argon, oxygen, nitrogen, carbon dioxide, water and combinations thereof. The second gaseous species of some embodiments comprises nitrogen.

Without being bound by any particular theory of operation, it is believed that once the storage vessel has been capped, the first gaseous species in the headspace will be able to any or all of adsorb, absorb or chemisorb to the storage medium in the pressurization component and cause the desorption of the second gaseous species from the storage medium into the headspace. For example, where water vapor is present in the headspace and nitrogen in the storage medium, the water molecules will exchange places with the nitrogen molecules while the temperature of the vessel is lowered. This allows the volume of the headspace to remain about the same during cooling of the storage vessel and contents instead of the reduced volume expected without the pressurization component. It will be understood by those skilled in the art that cooling of the storage vessel can be either active or passive cooling. Generally, the headspace has a first volume before attachment of the storage vessel pressurization component to the storage vessel and a second volume after the attachment of the storage vessel pressurization component to the storage vessel. In some embodiments, the second volume is greater than about 80% of the first volume, or greater than about 85%, 90%, 95%, 100%, 105%, 110% of the first volume. In specific embodiments, the second volume is in the range of about 80% to about 120%, or about 85% to about 115%, or about 90% to about 110%, or about 95% to about 105% of the first volume.

The storage medium 102 can be any suitable medium capable of holding and releasing the second gaseous species and holding the first gaseous species. The term “holding” used in this respect includes the chemisorption, physisorption, adsorption, or absorption of gaseous species to the storage medium 102. Examples of suitable storage media include, but are not limited to, adsorbents. Specific adsorbents include, but are not limited to, molecular sieves, carbon, activated carbon, and metal organic framework (MOF) compositions. Molecular sieves include aluminosilicate zeolites and other microporous materials.

A single storage medium component or a mixture of storage medium components can be employed. In some embodiments, the storage medium comprises substantially one component. As used in this specification and the appended claims, the term “substantially one component” means that the active component of the storage medium is greater than about 90%, 95% or 99% single component. For example, a storage medium comprising a zeolite mixed with an active binder having substantially one component means that of all active components present, which in this case excludes a non-active binder, at least about 90% is zeolite. Here, the binder is not a part of the storage medium as it is not present as a storage medium but may be included for structural purposes.

In some embodiments, the storage medium component comprises a mixture of more than one active component. For example, the storage medium can be a 1:1 mixture of zeolite and MOF, or a mixture of a zeolite and a binder that acts as an absorbent. Here, the binder acts as both a structural agent and an absorbent and is, therefore, an active component in the storage medium.

Suitable storage media may include a microporous aluminosilicate or zeolite having any one of the framework structures recognized by the International Zeolite Association (IZA). The framework structures include, but are not limited to those of the LTA, CHA, FAU, BEA, MFI, MOR types. Non-limiting examples of zeolites having these structures include zeolite A, chabazite, faujasite, zeolite Y, ultrastable zeolite Y, beta zeolite, mordenite, silicalite, zeolite X, and ZSM-5, sodium-exchanged and calcium-exchanged zeolites.

In a specific embodiment, the storage medium comprises one or more of 4A zeolite (also referred to as 4A molecular sieve), and 5A zeolite (also referred to as 5A molecular sieve). In a specific embodiment, the storage medium comprises substantially only sodium exchanged 4A zeolite. In certain embodiments, the storage medium comprises substantially only calcium exchanged 5A zeolite. In some embodiments, the storage medium comprises a mixture of 4A zeolite and 5A zeolite in a ratio in the range of about 1:100 to about 100:1. In certain embodiments, suitable zeolites includes those with SiO₂/Al₂O₃ less than about 10, or less than about 9, or less than about 8, or less than about 7, or less than about 6, or less than about 5, or less than about 4, or less than about 3, or less than about 2.5 or less than about 2.

According to one or more embodiments of the invention, storage medium compositions including non-zeolitic molecular sieves are provided. As used herein, the terminology “non-zeolitic molecular sieve” refers to corner sharing tetrahedral frameworks where at least a portion of the tetrahedral sites are occupied by an element other than silicon or aluminum. Non-limiting examples of such molecular sieves include aluminophosphates and metal-aluminophosphates, wherein metal could include silicon, copper, zinc or other suitable metals.

The storage medium may be “charged” or “loaded” with a specific amount of the second gaseous species prior to use. Alternatively, the amount of storage medium that may degrade or otherwise generate a specific amount of the second gaseous species may be selected prior to use. To increase the amount of the second gaseous species adsorbed to the storage medium and/or slow the natural desorption of the second gaseous species from the storage medium, the storage vessel pressurization component, or just the storage medium, may be maintained at sub-room temperature. In some embodiments, the storage vessel pressurization component 100 is stored at temperature less than about 15° C. prior to attachment of the storage vessel pressurization component to the storage vessel. In one or more embodiments, the storage vessel pressurization component is maintained at a temperature less than about 10° C. prior to being placed adjacent the opening of the storage vessel.

In the example where the first gaseous species is water and the second gaseous species is nitrogen, it may be useful to store the sorbent media at low temperature or high pressure. Storage at either sub-room temperature or increased nitrogen pressure can increase the amount of nitrogen stored per gram adsorbent. Storing a larger amount of nitrogen will allow for the use of a smaller amount of storage media. Table 1 lists the storage capacity of nitrogen on various adsorbents stored under different temperature and pressure conditions. These values are merely exemplary and should not be taken as limiting the scope of the invention.

TABLE 1

| Storage Medium | mmol N₂/g | wt % |
|---|---|---|
| Na X zeolite (25° C. at 1 atm N₂) | 0.48 | 1.34% |
| 1: 1LiX (25° C. at 1 atm N₂) | 1.3 | 3.64% |
| 4A zeolite (25° C. at 1 atm N₂) | 0.17 | 0.48% |
| 5A zeolite (CaA) (25° C. at 1 atm N₂) | 0.4 | 1.12% |
| 5A zeolite (CaA) (25° C. at 2 atm N₂) | 0.91 | 2.55% |

Once the storage vessel pressurization component is positioned within the storage vessel and sealed, the exchange of first gaseous species and second gaseous species on the adsorbent impacts the headspace volume and/or pressure. In some embodiments, water vapor will adsorb onto the storage medium more rapidly than the time needed for the temperature of the bottle to decrease. In this case, the pressure would initially increase with the adsorption of water vapor and rapid desorption of nitrogen. The rapid increase in pressure can cause the storage vessel to deform temporarily. To lower the rate of nitrogen release, a lower permeability material may be placed between the headspace and the storage medium. This material can be any suitable material capable of providing a hindrance to but allowing water vapor to diffuse there through.

In some embodiments, the storage vessel pressurization component comprises a barrier material which may include a lower permeability polymer. The lower permeability polymer can be any suitable material having a permeability sufficient for the intended purpose, for example, HDPE, LDPE, PVA, polysulfones or mixtures thereof. Many materials may allow a more rapid permeation of water vapor than nitrogen, in which case it may be advantageous to have one or more holes or openings in the barrier material to allow nitrogen to pass through so as not to cause a high pressure of nitrogen on the adsorbent side of the barrier.

The barrier material may also have a variable diffusion rate. The variability of the diffusion rate can be dependent upon, for example, one or more environmental factors or specific stimuli, for example, exposure to water vapor. A mixed species materials having two or more components can exhibit the variability, where one component may dissolve or become more porous when exposed to water or water vapor. The amount of the individual components in a mixed component system may be modified depending on the specific permeability properties desired.

Another means of slowing the diffusion of water vapor toward the storage medium is to provide a barrier that decreases the area that the water vapor can diffuse through. For example, a barrier material that is substantially impermeable to water vapor may be placed between the headspace and the storage medium. The barrier material in this case might have a series of holes or slits to allow some gases to pass through.

FIG. 5 shows another embodiment of a storage vessel 110 with a storage vessel pressurization component 100 positioned therein. The storage vessel 110 of this embodiment has a fluid 120 with a pressurization component 100 at the bottom of the vessel submerged within the fluid 120. The pressurization component 100 can absorb liquid from the fluid 120 and release a gaseous species which might bubble through the fluid 120 to become part of the headspace 130. Alternatively, the pressurization component 100 can absorb liquid from the fluid 120 and degrade or react to generate the gaseous species. The pressurization component 100 can be present in a sachet or encased in, for example, a polymer. The pressurization component 100 can be affixed to the bottom of the vessel prior to filling. The component 100 can be coated with a food safe polymer which allows the second gaseous species to diffuse or pass therethrough and fluid molecules from the fluid to diffuse or pass therethrough.

### EXAMPLES

In each of the following examples, a bottle is filled with a hot aqueous liquid such that, at the end of filling, the average temperature in the bottle is 160° F. (71° C.) and there is a 25 cc (25 mL) headspace in the bottle. The resulting vapor pressure of water is 4.8 psia (33 kPa), the total pressure above the liquid in the bottle is atmospheric pressure (approximately 14.7 psia (101 kPa)).

### Comparative Example 1

The bottle is capped with an impermeable material and allowed to cool to ambient temperature, about 70° F. (21° C.). The resulting temperature change causes the water vapor pressure to reduce to 0.4 psia (2.8 kPa). Assuming that the bottle does not deform, then the resulting drop in water vapor pressure from 4.8 psia (33 kPa) to 0.4 psia (2.8 kPa), a 4.4 psia (30 kPa) change, causes the total pressure to drop from 14.7 psia (101 kPa) to 10.3 psia (71 kPa) (14.7 psia−4.4 psia (101 kPa−71 kPa)). The drop in pressure causes a vacuum in the bottle.

### Example 2

Calcium A adsorbent is held under nitrogen in a dry environment at atmospheric pressure with loading properties described in Table 1. The bottle is capped with an impermeable material in which 0.84 grams of a Calcium A zeolite is added to the inside of the cap. The water vapor pressure reduces to 0.4 psia (2.8 kPa) upon cooling to 70° F. (21° C.). Simultaneously the adsorbent adsorbs water from the vapor space which would be replaced by the bulk liquid, and adsorbed phase nitrogen is released from the surface. Assuming the bottle does not deform, upon cooling to 70° F. (21° C.) no vacuum would be observed.

### Comparative Example 3

The bottle is next capped with an impermeable material. Upon cooling to ambient temperature, for example 70° F. (21° C.), the resulting temperature change causes the water vapor pressure to reduce to 0.4 psia (2.8 kPa). If the bottle now deforms such that the pressure inside the bottle is the same as atmospheric pressure, then the resulting drop in water vapor pressure from 4.8 psia (33 kPa) to 0.4 psia (2.8 kPa) results in a change in headspace of approximately 7.5 cc (7.5 mL). This results in a final headspace of 17.5 cc (7.5 mL) (17.5 mL).

### Example 4

Calcium A adsorbent is held under nitrogen in a dry environment at atmospheric pressure with loading properties described in Table 1. The bottle is capped with an impermeable material in which 0.84 grams of a Calcium A zeolite is added to the inside of the cap. The water vapor pressure reduces to 0.4 psia (2.8 kPa) upon cooling to 70° F. (21° C.). Simultaneously the adsorbent adsorbs water from the vapor space which would be replaced by the bulk liquid, and adsorbed phase nitrogen is released from the adsorbent. If the bottle now deforms such that the pressure inside the bottle is the same as atmospheric pressure, then the resulting drop in water vapor pressure from 4.8 psia (33 kPa) to 0.4 psia (2.8 kPa) would result in a change in headspace of approximately 7.5 cc (7.5 mL). The change in volume is replaced by release of nitrogen from the surface of the adsorbent.

### Example 5

Calcium A adsorbent is held under nitrogen in a dry environment at atmospheric pressure with loading properties described in Table 1. The bottle is capped with an impermeable material in which 0.84 grams of a Calcium A zeolite is added to the inside of the cap. The cap has an interior diameter of 1.5 inches and further a layer of low density polyethylene (LDPE) is added to the cap that is 0.01 cm thick such that it is between the adsorbent and the liquid in the bottle and covers the diameter of the cap. The water vapor pressure reduces to 0.4 psia (2.8 kPa) upon cooling to 70° F. (21° C.). Simultaneously the adsorbent adsorbs water from the vapor space which would be replaced by the bulk liquid, and adsorbed phase nitrogen is released from the surface. If the bottle now deforms such that the pressure inside the bottle is the same as atmospheric pressure, then the resulting drop in water vapor pressure from 4.8 psia (33 kPa) to 0.4 psia (2.8 kPa) results in a change in headspace of approximately 7.5 cc (7.5 mL) which is replaced by the release of nitrogen from the adsorbent. With the LDPE in place, the initial rate of N₂ release is estimated at 0.001 scc/sec. Holding the bottle at 160° F. for a period of 8 hours, all of the N₂ stored on the surface will be released.

### Example 6

Calcium A adsorbent is held under nitrogen in a dry environment at 2 atmospheres pressure with loading properties described in Table 1. The bottle is next capped with an impermeable material in which 0.52 grams of a Calcium A zeolite is added to the inside of the cap. The water vapor pressure reduces to 0.4 psia (2.8 kPa) upon cooling to 70° F. (21° C.). Simultaneously, the adsorbent adsorbs water from the vapor space which would be replaced by the bulk liquid, and adsorbed phase nitrogen is released from the surface. If the bottle now deforms such that the pressure inside the bottle is the same as atmospheric pressure, then the resulting drop in water vapor pressure from 4.8 psia (33 kPa) to 0.4 psia (2.8 kPa) results in a change in headspace of approximately 7.5 cc (7.5 mL) which is replaced by the release of nitrogen from the surface of the adsorbent. Less adsorbent is required as compared to Example 4.

### Example 7

Calcium A adsorbent is held under nitrogen in a dry environment at atmospheric pressure and 5° C. with loading properties described in Table 1. The bottle is capped with an impermeable material in which 0.37 grams of a Calcium A zeolite added to the inside of the cap. The water vapor pressure reduces to 0.4 psia (2.8 kPa) upon cooling to 70° F. (21° C.). Simultaneously, the adsorbent adsorbs water from the vapor space which would be replaced by the bulk liquid, and adsorbed phase nitrogen is released from the surface. If the bottle now deforms such that the pressure inside the bottle is the same as atmospheric pressure, then the resulting drop in water vapor pressure from 4.8 psia (33 kPa) to 0.4 psia (2.8 kPa) results in a change in headspace of approximately 7.5 cc (7.5 mL) which would be replaced by the release of nitrogen from the surface of the adsorbent. Less adsorbent is required as compared to Example 4.

### Example 8

0.84 grams of calcium A adsorbent stored under a nitrogen atmosphere is added to a bag. Separately, a second material holding 1 gram of water (either as an adsorbed phase or liquid water is added to a bag). On one side of the second material is a permeable membrane, and on the other side is an impermeable membrane. The permeable membrane is placed in close proximity of the adsorbent. The adsorbent adsorbs the water and releases 7.5 cc (7.5 mL) of nitrogen.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments. The order of description of the above method should not be considered limiting, and methods may use the described operations out of order or with omissions or additions.

It is to be understood that the above description is intended to be illustrative, and not restrictive. Many other embodiments will be apparent to those of ordinary skill in the art upon reviewing the above description. The scope of the invention should, therefore, be determined with reference to the appended claims, along with the full scope of equivalents to which such claims are entitled.

What is claimed is:

1. A storage vessel pressurization component for use with a storage vessel having a headspace with a first gaseous species, the storage vessel pressurization component comprising a gas storage medium having a second gaseous species, wherein the gas storage medium is configured to release the second gaseous species to the headspace of the storage vessel and adsorb the first gaseous species from the headspace of the storage vessel.

2. The storage vessel pressurization component of the claim 1, wherein the gas storage medium comprises an adsorbent.

3. The storage vessel pressurization component of claim 2, wherein the adsorbent comprises one or more of carbon, activated carbon, a zeolite and a metal organic framework (MOF) composition.

4. The storage vessel pressurization component of claim 2, wherein the adsorbent comprises a zeolite.

5. The storage vessel pressurization component of claim 4, wherein the zeolite is selected from the group consisting of 4A zeolite, 5A zeolite and mixtures thereof.

6. The storage vessel pressurization component of claim 1, wherein the storage vessel is a bottle.

7. The storage vessel pressurization component of claim 6, wherein the bottle is a beverage bottle.

8. The storage vessel pressurization component of claim 1, wherein the storage vessel is a can.

9. The storage vessel pressurization component of claim 1, wherein the storage vessel is a flexible package.

10. The storage vessel pressurization component of claim 1, wherein the first gaseous species comprises water vapor.

11. The storage vessel pressurization component of claim 1, wherein the second gaseous species is selected from the group consisting of helium, argon, oxygen, nitrogen, carbon dioxide and combinations thereof.

12. The storage vessel pressurization component of claim 1, wherein the first gaseous species comprises water vapor and the second gaseous species comprises nitrogen.

13. The storage vessel pressurization component of claim 1, wherein the headspace has a first volume before attachment of the storage vessel pressurization component to the storage vessel and a second volume after the attachment of the storage vessel pressurization component to the storage vessel, the second value greater than about 80% of the first volume.

14. The storage vessel pressurization component of claim 13, wherein the storage vessel pressurization component is stored at temperature less than about 15° C. prior to attachment of the storage vessel pressurization component to the storage vessel.

15. The storage vessel pressurization component of claim 1, wherein the component comprises a sachet.

16. The storage vessel pressurization component of claim 1, further comprising a material impermeable to the first gaseous species, the material including at least one opening to allow the first gaseous species to diffuse therethrough.

17. The storage vessel pressurization component of claim 16, wherein the material impermeable to the first gaseous species comprises a polymer.

18. The storage vessel pressurization component of claim 1, further comprising a polymer bather.

19. The storage vessel pressurization component of claim 18, wherein the polymer barrier is gas permeable.

20. The storage vessel pressurization component of claim 18, wherein the polymer barrier is substantially impermeable to one or more of the first gaseous species and the second gaseous species.

21. The storage vessel pressurization component of claim 1, wherein the component is stored in an environment comprising one or more of sub-room temperatures and super-atmospheric pressure of the second gaseous species.

22. The storage vessel pressurization component of claim 1, wherein adsorbing the first gaseous species from the headspace comprises contacting the fluid.

23. A storage vessel pressurization component for use with a bottle having a liquid and a headspace with a first volume at elevated temperature, the headspace comprising water vapor, the storage vessel pressurization component comprising a composition with one or more of an amount of second gaseous species adsorbed thereon and an amount of a composition that generates the second gaseous species, the second gaseous species comprising nitrogen, the amount of the second gaseous species sufficient to exchange with the water vapor in the headspace so that when liquid cools to about room temperature the headspace has a second volume greater than about 80% of the first volume.

24. A method of manufacturing a beverage, the method comprising:
filling a storage vessel having an opening with an aqueous liquid to leave a known headspace volume above the liquid, the storage vessel filled at elevated temperatures greater than about 40° C., the headspace volume comprising a first gaseous species comprising water vapor;
placing a storage vessel pressurization component adjacent to the opening in the bottle, the storage vessel pressurization component comprising a sorbent with an amount of second gaseous species adsorbed thereon, the second gaseous species comprising nitrogen;
sealing the bottle with the storage vessel pressurization component adjacent the opening; and
cooling the storage vessel to about room temperature,
wherein the amount of the second gaseous species is sufficient to exchange with the first gaseous species in the headspace volume so that when the aqueous liquid cools to about room temperature the headspace has a second volume greater than about 80% of the first volume.

25. The method of claim 24, further comprising removing the storage vessel pressurization component from storage in an environment having one or more of sub-room temperature and elevated pressure.

26. A method of manufacturing a beverage, the method comprising:
filling a storage vessel having an opening with an aqueous liquid to leave a known headspace volume above the liquid, the storage vessel filled at elevated temperatures greater than about 40° C., the headspace volume comprising a first gaseous species comprising water vapor;
placing a storage vessel pressurization component in the bottle, the storage vessel pressurization component comprising a sorbent with an amount of second gaseous species adsorbed thereon, the second gaseous species comprising nitrogen;
sealing the bottle with the storage vessel pressurization component therein; and
cooling the storage vessel to about room temperature,
wherein the amount of the second gaseous species is sufficient to exchange with the first gaseous species in the headspace volume so that when the aqueous liquid cools to about room temperature the headspace has a second volume greater than about 80% of the first volume.

27. The method of claim 26, further comprising removing the storage vessel pressurization component from storage in an environment having one or more of sub-room temperature and elevated pressure.

28. An article comprising
a bottle holding a fluid and having a headspace; and
a storage vessel pressurization component within the bottle, wherein upon assembly of the bottle and the storage vessel pressurization component, there is substantially no change in the volume of the headspace or pressure within the bottle.

29. An article comprising:
a storage vessel having an opening, a fluid contained therein and a headspace; and
a storage vessel pressurization component within the storage vessel, the storage vessel pressurization component having molecules sorbed thereon, the molecules comprising fluid molecules.

30. A storage vessel pressurization component for use with a storage vessel having a headspace with a first gaseous species, the storage vessel pressurization component comprising a gas releasing medium having one or more of a second gaseous species and a composition from which a second gaseous species can be generated, wherein the gas releasing medium is configured to release the second gaseous species to the headspace of the storage vessel and adsorb the first gaseous species from the headspace of the storage vessel.

31. An article comprising a storage vessel having an opening, a fluid contained therein and a headspace; and the storage vessel pressurization component according to claim 30.
